(19) United States
(12) Patent Application Publication
(10) Pub. No.: US 2013/0162700 A1
(43) Pub. Date: Jun. 27, 2013

(54) DRIVE CIRCUIT, DRIVE METHOD, AND DISPLAY DEVICE

(71) Applicant: Ryo Yamakawa, Osaka-shi (JP)

(72) Inventor: Ryo Yamakawa, Osaka-shi (JP)

(73) Assignee: SHARP KABUSHIKI KAISHA, Osaka-shi, Osaka (JP)

(21) Appl. No.: 13/820,925

(22) PCT Filed: Sep. 8, 2011
(86) PCT No.: PCT/JP2011/070449

§ 371 Date: Mar. 5, 2013

(30) Foreign Application Priority Data
Sep. 15, 2010 (JP) 2010-206571

(51) Int. Cl. G09G 5/10

(52) U.S. Cl. CPC G09G 5/10
USPC 345/690

(57) ABSTRACT

A drive circuit is configured to drive a display panel including pixels and a backlight including LEDs. The display panel includes a critical light transmission level that is a minimum level for causing each pixel to respond in a predetermined time upon an input of an image. The drive circuit includes first and second circuits. The first circuit is configured to divide the image into areas and determine brightness levels of the LEDs for the areas based on the image. The second circuit is configured to determine a light transmission level based on the image and the brightness levels such that the level is higher than the critical level.

### TECHNICAL FIELD

The present invention relates to a drive circuit, a drive method, and a display device, in particular to a technology for driving a display device including a backlight while controlling brightness of the backlight and light transmission of a display panel.

### BACKGROUND ART

In recent years, high-performance liquid crystal display devices such as a large screen television have been widely used. The liquid crystal display device has advantages such as light weight and small heat radiation compared to a conventional monitor using cathode ray tubes. However, a liquid crystal display device including a backlight has problems in power consumption and responsiveness. The liquid crystal display device is developed to solve the problems.

Patent Document 1 discloses an area-active drive as a technology that reduces the power consumption of the liquid crystal display device including a backlight. According to this technology, a display is divided into a plurality of areas, and brightness of the backlight light sources for the corresponding areas is controlled depending on an input image corresponding to the areas. The area-active drive may reduce the brightness of the backlights for some areas depending on the input image. This reduces the power consumption.

Patent Document 2 discloses overdrive that is known as a technology for improving the responsive speed of the liquid crystal display device. According to this technology, if a gradation level of the liquid crystal display element is controlled to be risen from a gradation level A to a gradation level B, which is referred to as a rising response, an overshoot signal is applied to the liquid crystal display element as an image signal. In inputting the overshoot signal for the rising response, an image signal corresponding to a gradation level C that is higher than the gradation level B is input to the liquid crystal display element for a brief moment, and then, an image signal corresponding to the target gradation level B is input. If the gradation level of the liquid crystal display element is controlled to be decayed from the gradation level A to the gradation level B, which is referred to as a decaying response, another overshoot signal is applied to the liquid crystal element as an image signal. In inputting the overshoot signal for the decaying response, an image signal corresponding to a gradation level C that is lower than the gradation level B is input to the liquid crystal display element for a brief moment, and then, an image signal corresponding to the target gradation level B is input. In the overdrive, a liquid crystal molecular alignment is changed promptly by the input of the image signal corresponding to the gradation level C compared to a case that the image signal corresponding to the gradation level C is not input. This improves the response speed.

### RELATED ART DOCUMENT

### Patent Document

Patent Document 1: Japanese Unexamined Patent Publication No. 2009-198530

Patent Document 2: Japanese Unexamined Patent Publication No. 2005-172882

### Problem to be Solved by the Invention

The overdrive method improves the responsiveness of the liquid crystal display device, but may reduce display quality of the liquid crystal display device. In the overdrive drive method, the overshoot signal corresponding to the gradation level C is required to be applied. Depending on a period for which the overshoot signal corresponding to the gradation level C is applied or a level to be set, a white blur may appear on the display when the liquid crystal element is in the rising response. In addition, the display may be darkened when the liquid crystal element is in the decaying response. Particularly, when the gradation level A and the gradation level B are both low gradation levels and the voltage to be applied to the liquid crystal display element is low, a level difference between the target gradation level B and the overshoot signal corresponding to the gradation level C is required to be relatively large to improve the responsiveness, because the response speed of the liquid crystal is proportional to the square of the applied voltage. This may causes the above problems.

### DISCLOSURE OF THE PRESENT INVENTION

The present invention was accomplished in view of the above circumstances. It is an object of the present invention to provide a technology for obtaining both of the improvement in the responsiveness and the reduction in the degradation of the image quality in the display device including the backlight.

### Means for Solving the Problem

The inventors of the present invention have conducted studies to solve the above problems and found that the area-active drive can achieve both of the improvement in responsiveness and the reduction in the degradation of the image quality.

The present invention provides a following drive circuit to solve the above problem. The drive circuit is configured to drive a display panel and a backlight. The display panel includes a plurality of pixels and the backlight includes a plurality of light sources. The display panel includes a critical light transmission level that is set in advance. The critical light transmission level is a minimum level of light transmission level for causing each of the pixels to respond in a predetermined time upon an input of an input image. The drive circuit includes a brightness level determining circuit and a light transmission level determining circuit. The brightness level is configured to divide the input image into a plurality of areas and determine brightness levels for the areas based on the input image corresponding to the areas. The light transmission level determining circuit is configured to determine light transmission levels based on the input image and the brightness levels such that the light transmission levels are higher than the critical light transmission level. The brightness levels indicate brightness of the light sources corresponding to the areas. The light transmission levels indicate light transmission of the pixels.

In this drive circuit, upon the input of the input image, the light transmission level determining circuit determines the light transmission level such that the determined light transmission level is higher than the critical light transmission level. Accordingly, the response change of each pixel based on the determined light transmission level is set to be in the predetermined time. In the drive circuit, the response time of the pixels of the display panel that is generally slower than the brightness change of the light sources of the backlight is set to be in the predetermined time, so that certain responsiveness can be obtained. In addition, the overshoot signal is not required for improvement of the responsiveness of the display panel. Even in a case that the overshoot signal is used, the level difference between the target gradation level B and the overshoot signal corresponding to the gradation level C is reduced. This reduces the degradation of the image quality.

Preferably, the predetermined time is set based on a switching period in which the input image is switched. In this drive circuit, the responsiveness that corresponds to the switching of the input image can be obtained. Accordingly, if the input image to be inputted to the drive circuit is successively switched per the predetermined switching period, the display panel can be changed accordingly. This reduces the degradation of the image quality of the input image to be displayed on the display panel.

The brightness level determining circuit includes a brightness table including the brightness levels each associated with each of the areas. In this drive circuit, the drive circuit can determine the brightness level for each area based on the brightness table. This facilitates the determining process of the brightness level determining circuit.

The drive circuit may further include a detection section configured to detect a maximum gradation level for each of the areas of the input image. In this case, preferably, the brightness levels in the brightness table are determined based on the maximum gradation level for each of the areas with which each of the brightness levels is associated. In this drive circuit, even when the brightness level of each of the light sources of the backlight is made small, the drive circuit can control the light transmission of the pixels of the display panel, and thus the input image can be properly reproduced.

The light transmission level determining circuit may include a light transmission table including the light transmission levels each associated with each of pixels. In this case, preferably, the light transmission levels in the light transmission table are determined based on the brightness levels in the brightness table for each of the pixels with which each of the light transmission levels is associated.

In this drive circuit, the light transmission level determining circuit includes a light transmission table and the light transmission levels are determined using the transmission. This facilitates the determining process of the light transmission level determining circuit. In the drive circuit, the light transmission level of the light transmission table is determined based on the brightness level of the corresponding brightness table. In addition, in this drive circuit, the light transmission levels in the light transmission table are determined based on the brightness levels in the brightness table. With this configuration, if the brightness level is made relatively small, the light transmission level is made relatively large to maintain the image reproducibility. According to the drive circuit, the power consumption can be reduced by making the brightness level to be relatively small, and the responsiveness of the display panel can be improved and the degradation of the image quality can be reduced by making the light transmission levels to be relatively large.

The present invention may be embodied as a method of driving the above drive circuit. The present invention provides a following method of driving a display panel and a backlight. The display panel includes a plurality of pixels and the backlight including a plurality of light sources. The display panel includes a critical light transmission level that is set in advance. The critical light transmission level is a minimum level of light transmission levels for causing each of the pixels to respond in a predetermined time upon an input of an input image. The method includes dividing the input image into a plurality of areas and determining brightness levels for the areas based on the input image corresponding to the areas, and determining a light transmission levels based on the input image and the brightness levels such that the light transmission levels are higher than the critical transmission level. The brightness levels indicate brightness of the light sources corresponding to the areas. The employment of this method can embody the above drive circuit, and thus the improved responsiveness and the reduced degradation of display quality can be obtained. The light transmission levels indicate light transmission of the pixels.

The present invention may also be embodied as a display device including the above drive circuit. The display device according to the present invention is configured to control a brightness of a backlight. The display device includes a display panel including a plurality of pixels, a backlight including a plurality of light sources, a brightness level determining circuit, a light transmission level determining circuit, a backlight driving section, and a panel driving section. The display panel includes a critical light transmission level that is set in advance. The critical light transmission level is a minimum level of light transmission levels for causing each of the pixels to respond in a predetermined time upon an input of the input image. The brightness level determining circuit is configured to divide an input image into a plurality of areas and determine brightness levels for the areas based on the input image corresponding to the areas. The brightness levels indicating brightness of the light sources corresponding to the areas. The light transmission level determining circuit is configured to determine light transmission levels based on the input image and the brightness levels such that the light transmission levels are higher than the critical light transmission level. The light transmission levels indicate light transmission of the pixels. The backlight driving section is configured to control the brightness of each of the light sources of the backlight based on the brightness levels. The panel driving section is configured to control the light transmission of each of the pixels of the display panel based on the light transmission level. The display device including the above drive circuit can improve the responsiveness and reduce the degradation of the image quality.

The backlight drive section is configured to change a duty cycle of current applied to each of the light sources for controlling the brightness of each of the light sources. In the display device, the current to be applied from the backlight drive section to the light sources is switched to an ON-state current or an OFF-state current. The current between the ON-state current and the OFF-state current is not required to be applied to the light sources. This enables the display device to have the backlight drive section with a simple output part.

Preferably, the light sources are LEDs. This enables a backlight including LEDs to have improved responsiveness and reduced degradation in the display quality.

Preferably, the display panel is a liquid crystal panel using liquid crystals. This can improve responsiveness and reduce image degradation in the liquid crystal panel used in a large screen television.

### Advantageous Effect of the Invention

According to the present invention, the responsiveness can be improved and the image degradation can be reduced in the display device including the backlight.

### BRIEF DESCRIPTION OF THE DRAWINGS

FIG. 1 is a view illustrating a configuration of a display device 10;

FIG. 2 is a magnified view of a liquid crystal panel 40;

FIG. 3 is a view illustrating an equivalent circuit of a pixel 40;

FIG. 4 is a brightness table Tk;

FIG. 5 is a light transmission table Th;

FIG. 6 is a process flow diagram of a drive circuit 12;

FIG. 7 is a graph indicating a relation between a data voltage V and a change rate F;

FIG. 8 is a graph indicating a relation between a gradation level X and brightness B;

FIG. 9 is a graph indicating a relation between a gradation level X and a data voltage V; and

FIG. 10 is a graph indicating a relation between a gradation level X and a duty cycle D.

### MODE FOR CARRYING OUT THE INVENTION

### First Embodiment

The first embodiment of the present invention will be described with reference to the drawings.

### 1. Configuration of the Display Device

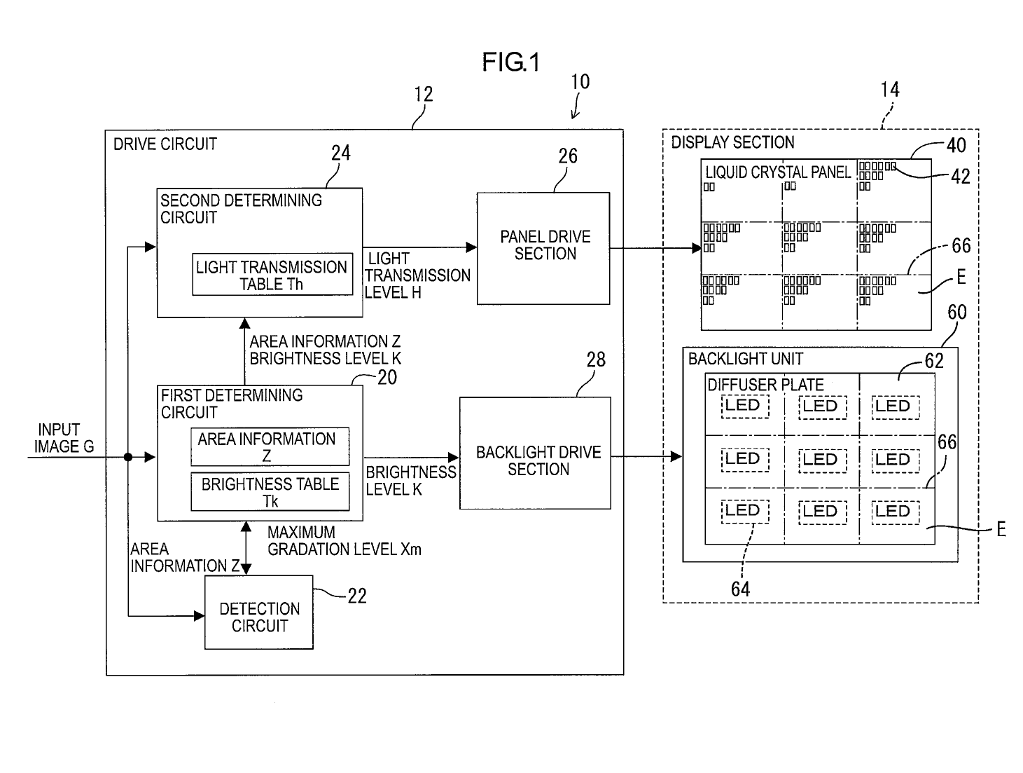

As illustrated in FIG. 1, a display device 10 includes a drive circuit 12 and a display section 14. The display section 14 includes a liquid crystal panel 40 (an example of a liquid crystal display element) and a backlight unit 60.

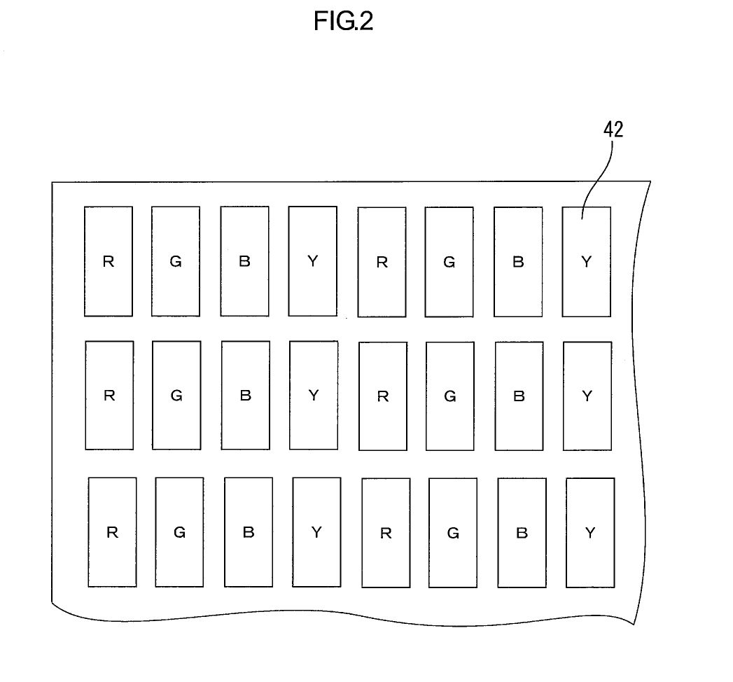

The liquid crystal panel 40 includes a plurality of pixels 42. FIG. 2 is a magnified view of apart of the liquid crystal panel 40. The liquid crystal panel 40 includes four kinds of pixels 42 (an example of display element). The pixels 42 include a pixel R through which a red light passes, a pixel G through which a green light passes, a pixel B through which a blue light passes, and a pixel Y through which a yellow light passes. The pixel R, the pixel G, the pixel B, and the pixel Y are aligned in a row in this order and such a row is aligned in columns.

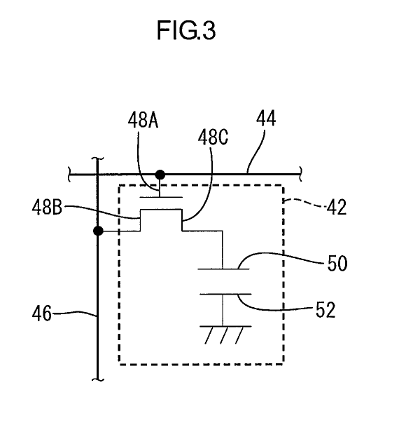

FIG. 3 illustrates an equivalent circuit of the pixel 42. The liquid crystal panel 40 includes a plurality of scan lines 44 and a plurality of data lines 46. The scan lines 44 and the data lines 46 extend between the pixels 42. The pixel 42 includes a switch device 48 and a pixel electrode 50. The switch device 48 includes a switching electrode 48A and data electrodes 48B, 48C. The switching electrode 48A is connected to the corresponding scan line 44. The data electrode 48B is connected to the corresponding data line 46 and the data electrode 48C is connected to the pixel electrode 50. The pixel electrode 50 is arranged to face counter electrode 52 via liquid crystal molecules enclosed in the liquid crystal panel 40. The counter electrode 52 is connected to a ground voltage.

As illustrated in FIG. 1, the backlight unit 60 is arranged behind the liquid crystal panel 40. The backlight unit 60 includes a diffuser plate 62 and a plurality of LEDs 64 (Light Emitting Diode) as light sources. The LEDs 64 are arranged to face a rear surface of the diffuser plate 62. The diffuser plate 62 has a main surface facing the liquid crystal panel 40. Light from the LEDs 64 enters the diffuser plate 62 from its rear surface and passes therethrough while being diffused. The diffused light exits through the main surface of the diffuser plate 62 facing the liquid crystal panel 40 to be applied to the liquid crystal panel 40. The backlight unit 60 is a direct-type backlight unit in which the LEDs 64 are arranged on a rear side of the diffuser plate 62 in a thickness direction thereof.

The drive circuit 12 is configured to drive the liquid crystal panel 40 and the backlight unit 60 based on an input image G supplied from an external device (not illustrated). The drive circuit 12 includes a first determining circuit 20 (an example of a brightness level determining circuit), a detection circuit 22, a second determining circuit 24 (an example of a light transmission level determining circuit), a panel drive section 26, and a backlight drive section 28.

The first determining circuit 20 determines brightness level K. The brightness level K is used to determine brightness of the LEDs 64 included in the backlight unit 60. The display section 14 of the display device 10 includes a plurality of areas E (areas divided by imaginary lines 66) corresponding to an arrangement of the LEDs 64 included in the backlight unit 60. The first determining circuit 20 stores area information Z regarding the areas E. The first determining circuit 20 divides the input image G into the areas E based on the area information Z and determines the brightness level K for each area E based on the input image corresponding to the areas E.

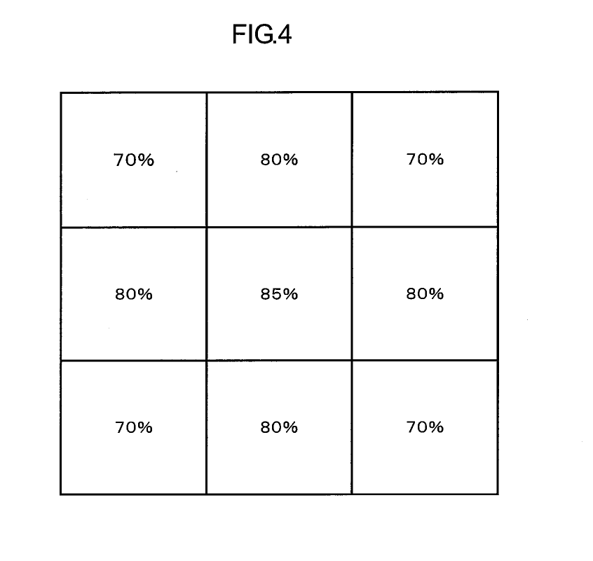

The first determining circuit 20 stores a plurality of brightness tables Tk. As illustrated in FIG. 4, the brightness table Tk includes brightness levels K each of which is associated with each of areas E. The first determining circuit 20 selects one of the brightness tables Tk based on the input image G and determines the brightness level K for each area E based on the brightness table Tk.

The detection circuit 22 detects the maximum gradation level Xm of the input image G. The detection circuit 22 is connected to the first determining circuit 20 so that the area information Z is supplied from the first determining circuit 20 to the detection circuit 22. The detection circuit 22 divides the input image G into the areas E based on the area information Z, and detects the maximum gradation level Xm for each area E of the input image G, and then transmits the maximum gradation levels Xm to the first determining circuit 20. The first determining circuit 20 to which the maximum gradation levels Xm are transmitted selects one of the brightness tables Tk based on the maximum gradation level Xm for each area E of the input image G.

The second determining circuit 24 determines the light transmission level H. The light transmission level H is used to determine the light transmission of the pixel 42 of the liquid crystal panel 40. The second determining circuit 24 is connected to the first determining circuit 20 so that the first determining circuit 20 transmits the area information Z and the brightness level K to the second determining circuit 24. As illustrated in FIG. 1, the pixels 42 of the liquid crystal panel 40 each are in any one of areas corresponding to the areas E of the backlight unit 60 and have the corresponding brightness level K. The second determining circuit 24 determines the light transmission level H for each pixel 42 based on the input image G corresponding to pixels 42 and the corresponding brightness level K.

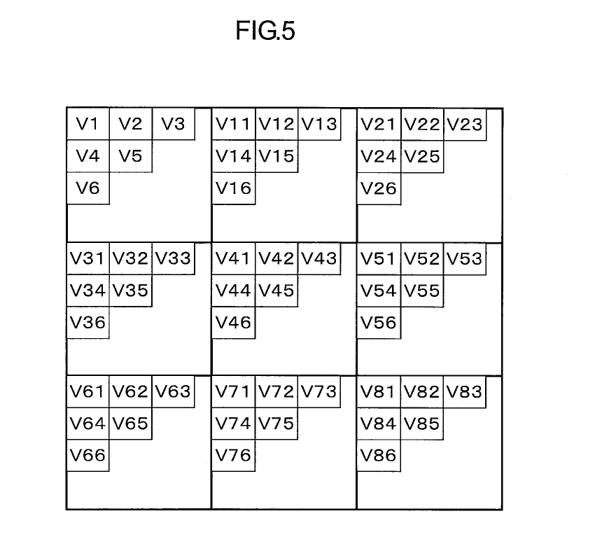

The second determining circuit 24 stores a plurality of light transmission tables Th. As illustrated in FIG. 5, each of the light transmission tables Th includes light transmission levels H each associated with each of the pixels 42 of the liquid crystal panel 40. The second determining circuit 24 selects one of the light transmission tables Th based on the input image G and determines the light transmission level H for each pixel 42 based on the light transmission table Th.

The backlight drive section 28 is configured to drive the backlight unit 60 of the display section 14. The backlight drive section 28 is connected to the first determining circuit 20 so that the first determining circuit 20 transmits the brightness level K to the backlight drive section 28. In addition, the backlight drive section 28 is independently connected to each of the LEDs 64 of the backlight unit 60 to supply current to each LED 64. The backlight drive section 28 varies a duty cycle D of the current supplied to the LED 64 based on the brightness level K transmitted from the first determining circuit 20. This varies continuous lighting time of the LED 64, and thus the brightness of the LED 64 can be controlled. In other words, the backlight drive section 28 controls the brightness of the LED 64 based on the brightness level K transmitted from the first determining circuit 20.

The panel drive section 26 is configured to drive the liquid crystal panel 40 included in the display section 14. The panel drive section 26 is connected to the second determining circuit 24 so that the second determining circuit 24 transmits the light transmission level H to the panel drive section 26. In addition, the panel drive section 26 is connected to each pixel 42 of the liquid crystal panel 40 to apply data voltage V to each pixel 42. The panel drive section 26 controls the data voltage V applied to each pixel based on the light transmission level H transmitted from the second determining circuit 24.

As illustrated in FIG. 3, the data voltage V is applied to the pixel 42 through the data line 46 when the switch device 48 is switched on by the signal applied to the scan line 44. Then, the data voltage V is applied to the pixel electrode 50 through the switch device 48. Accordingly, the data voltage V is applied to the liquid crystal molecules to change the alignment of the liquid crystal molecules. This changes the light transmission of the pixel 42 is changed. In other words, the panel drive section 26 controls the light transmission of the pixel 42 based on the light transmission level H transmitted from the second determining circuit 24.

### 2. Control of the Display Device

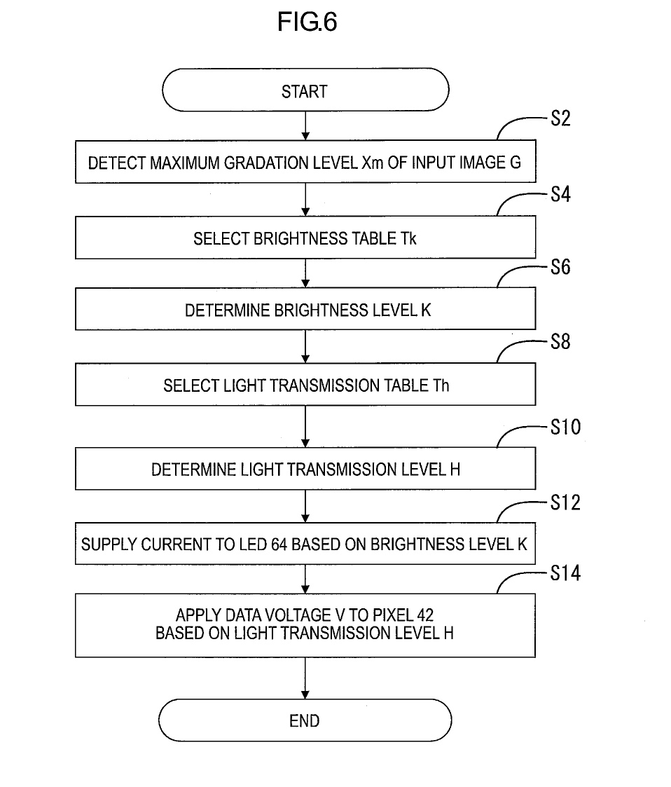

A display processing of the input image G in the display device 10 is explained with reference to FIG. 6.

Upon an input of the input image G from an external device to the drive circuit 12, the detection circuit 22 receives the area information Z from the first determining circuit 20 and detects the maximum gradation level Xm for each area of the input image G (step S2). Then, the detection circuit 22 transmits the maximum gradation level Xm to the first determining circuit 20.

Next, upon the receipt of the maximum gradation level Xm transmitted from the detection circuit 22, the first determining circuit 20 selects one of the brightness tables Tk based on the maximum gradation level Xm (step S4). The first determining circuit 20 stores various brightness tables Tk for different intended usages and usage environments. Specifically, the first determining circuit 20 stores various brightness tables Tk corresponding to reference images determined according to the intended usages and usage environments. The first determining circuit 20 selects one of the brightness tables Tk.

In the selection of one of the brightness tables Tk, the first determining circuit 20 selects one of the brightness tables Tk that satisfies the following conditions. (1) The brightness table Tk includes the brightness levels for each area E each of which is higher than a level obtained by converting the maximum gradation level X for each area E into the brightness level K.

(2) The sum of the brightness levels K for areas E is the smallest among the brightness tables Tk.

By fulfilling the condition (1), when the input image G is displayed on the display section 14, the first determining circuit 20 can reproduce the input image G by the brightness of the light emitted from the LED 64 and the light transmission of the liquid crystal panel 40. Further, when the second condition is fulfilled, less power is required to drive the LEDs 64.

The first determining circuit 20 determines the brightness levels K based on the selected brightness table Tk (step S6), and transmits the determined brightness levels K to the second determining circuit 24 and the backlight drive section 28.

Next, upon an input of the brightness level K from the first determining circuit 20, the second determining circuit 24 receives the area information Z from the first determining circuit 20 and selects one of the light transmission tables Th based on the information Z and the brightness level K (step S8). The second determining circuit 24 stores various light transmission tables Th each corresponding to each of the brightness tables Tk stored in the first determining circuit 20. Specifically, the second determining circuit 24 stores various light transmission tables Tk related to the brightness tables Tk stored in the first determining circuit 20.

The second determining circuit 24 is configured to determine which one of the brightness tables Tk is selected by the first determining circuit 24 and select one of the light transmission tables Th that is related to the selected brightness table Tk.

The second determining circuit 24 determines the light transmission levels H based on the selected light transmission table Th (step S10), and then transmits the light transmission levels H to the panel drive section 26.

Next, the backlight drive section 28 determines the duty cycle D of the current supplied to the LEDs 64 based on the brightness levels K supplied from the first determining circuit 20, and drives the backlight unit (step S12). As illustrated in FIG. 4, the brightness levels K are expressed in percentage. The backlight drive section 28 converts the brightness levels K each expressed in percentage into the duty cycle D, and then supplies the current to the LEDs 64.

Next, the panel drive section 26 determines the data voltage V applied to the pixel 42 based on the light transmission level H transmitted from the second determining circuit 24, and drives the liquid crystal panel 40 (step S14). As illustrated in FIG. 5, the light transmission level H includes the levels of the data voltages V. The panel drive section 26 applies the data voltages V to the pixels 42.

### 3. Characteristics of the Display Device

Upon the transmission of the input image G from the external device to the display device 10, the drive circuit 12 controls the brightness of the LEDs 64 of the backlight unit 60 based on the input image G and controls the light transmission of the pixels 42 of the liquid crystal panel 40. Accordingly, the amount of light emitted from the LEDs 64 is controlled in the display section 14 and the amount of light passing through the pixels 42 is controlled. As a result, the amount of light recognized by the user through the display section 14 is controlled, and the input image G is reproduced on the display section 14.

In the display device 10, when a moving image is displayed, for example, the input image G to be supplied changes at predetermined intervals T. In the backlight unit 60, when the duty cycle D of the current supplied to the LEDs 64 is changed according to the change of the input image G, the brightness of the LEDs 64 changes accordingly. However, in the liquid crystal panel 40, a response speed of the liquid crystals is slower than a change rate of brightness of the LEDs 64. Thus, when the data voltage V applied to the pixels 42 according to the change of the input image G, the light transmission of the pixels 42 may be difficult to be changed accordingly.

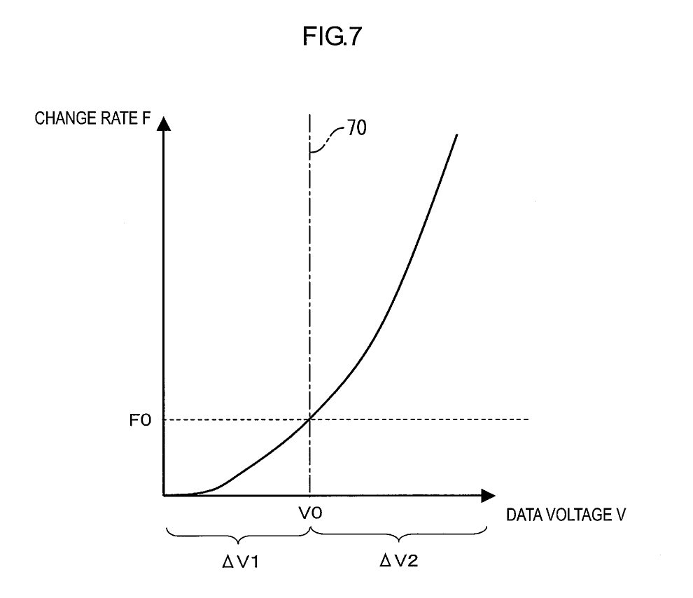

FIG. 7 indicates a relation between the data voltage V applied to the pixels 42 and the change rate F of the light transmission of the liquid crystal panel 40. Generally, in the liquid crystal panel 40, the change rate F of the light transmission is proportional to the square of the data voltage V. Accordingly, as illustrated in FIG. 7, in the liquid crystal panel 40, the data voltage V is larger than a one-dotted chain line 70 in an area ΔV2 in which the change rate F is larger than the reference rate F0, and the data voltage V is smaller than the one-dotted chain line 70 in an area ΔV1 in which the change rate F is smaller than the reference rate F0.

The reference rate F0 is determined depending on the change rate of the input image G. For example, the input image G that changes at 240 Hz is input, the reference rate F0 is determined based on the change rate. In the liquid crystal panel 40, if the change rate F is lower than the reference rate F0, the change of the light transmission of the pixels 42 cannot be completed in a reference time T0 (=1/ΔF0) for displaying one input image G on the display device 10. In other words, the data voltage V0 for the reference rate F0 is a critical data voltage V0 that is the minimum data voltage for causing each pixel 42 to respond in a predetermined time T0 upon the input of the input image G. The critical data voltage V0 is a constant determined depending on the response time of the liquid crystal included in the liquid crystal panel 40, for example. The critical data voltage V0 is determined for each liquid crystal panel 40.

Further, a critical light transmission level H0 is determined based on the critical data voltage V0. The critical data voltage V0 is the minimum light transmission level for enabling each pixel 42 to respond in the reference time T0 upon the input of the input image G.

In the display device 10 according to this embodiment, the second determining circuit 24 determines the light transmission level H to be higher than the critical transmission level H0. Specifically, in the second determining circuit 24, each of the light transmission tables Th includes the light transmission levels H higher than the critical light transmission level H0 in relation to each pixel 42. In the first determining circuit 20, in addition to the above, the brightness tables Tk each include the brightness levels K corresponding to the light transmission levels H higher than the critical light transmission level H0 in relation to each area E. The second determining circuit 24 determines the light transmission level H based on the brightness table Tk and the light transmission table Th such that the determined light transmission level H is higher than the critical light transmission level H0.

### 4. Effects of the Invention

(1) In the drive circuit 12 according to the present embodiment, upon the input of the input image G, the second determining circuit 24 determines the light transmission level such that the determined light transmission level H is higher than the critical light transmission level H0. Accordingly, the data voltage V larger than the critical data voltage V is applied to the pixels 42 of the liquid crystal panel 40, and the response change of each pixel 42 is set to be in the reference time T0. In the drive circuit 12, the response time of the pixels 42 of the liquid crystal panel 40 that is generally slower than the brightness change of the LEDs 64 of the backlight unit 60 is set to be in the reference time T0, so that certain responsiveness can be obtained. In addition, the overshoot signal is not required for improvement of the responsiveness of the liquid crystal panel 40. This reduces the degradation of the image quality.

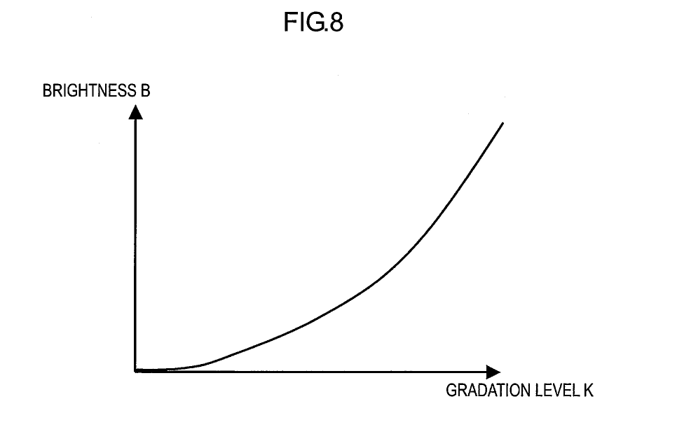

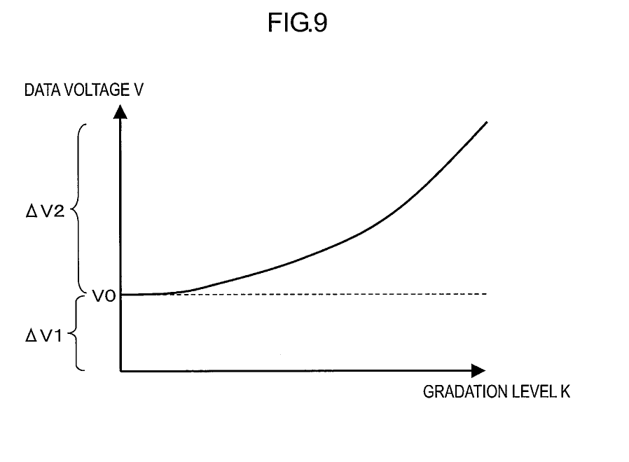

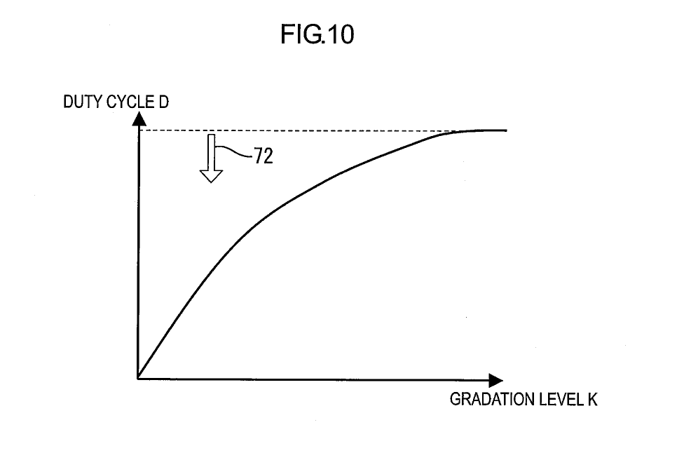

FIG. 8 to FIG. 10 indicates a relation between a gradation level X of the input image G and the brightness B of the display section in the display device 10 of this embodiment. The relation is indicated by using the data voltage V applied to the liquid crystals and the duty cycle D of the LED 64. As indicated in FIG. 8 and FIG. 9, in the display device 10 of the present embodiment, the data voltage V is not lower than the critical data voltage V0 even if the gradation level X of the input image G is low. The responsiveness of a certain level is maintained. Further, as indicated in FIG. 8 and FIG. 10, in the display device 10 of the present embodiment, the duty cycle D of the LED 64 is lowered (see an arrow 72) when the gradation level X of the input image G is low. Accordingly, when the gradation level X of the input image G is low, the power for driving the LED 64 can be reduced.

(2) In the drive circuit 12 of this embodiment, the reference time T0 is determined based on the period for which the input image G displayed on the display device 10. In this drive circuit 12, the responsiveness corresponding to the switching of the input image G can be obtained. Accordingly, if the input image G to be inputted to the drive circuit 12 is successively switched, the light transmission of each pixel 42 of the liquid crystal panel 40 can be changed accordingly. This reduces the degradation of the image quality of the input image G to be displayed on the liquid crystal panel 40.

(3) Preferably, the backlight drive section 28 of the present embodiment is configured to change a duty cycle of the current applied to each LED 64 for controlling the brightness of each LED 64. In the display device 40, the current to be applied from the backlight drive section 28 to the LEDs 64 is switched to an ON-state current or OFF-state current. The current between the ON-state current and the OFF-state current is not required to be applied to the LEDs 64. This enables display device 10 to have the backlight drive section 28 with a simple output part.

### Other Embodiments

The present invention is not limited to the above embodiments described in the above description and the drawings. The following embodiments are also included in the technical scope of the present invention, for example.

(1) In the above embodiment, the circuits such as the first determining circuit 20, the detection circuit 22, and the second determining circuit 24 included in the drive circuit 12 are separate circuits. However, the circuits may be one circuit.

(2) In the above embodiment, the backlight unit 60 includes nine LEDs and the display section 14 is divided into nine areas E corresponding to the LEDs. However, the display section 14 may be divided into other than nine areas E. In addition, two or more LEDs 64 may be provided for one area E.

### EXPLANATION OF SYMBOLS

10: display device, 12: drive circuit, 14: display section, 20: first determining circuit, 22: detection circuit, 24: second determining circuit, 26: panel drive section, 28: backlight drive section, 40: liquid crystal panel, 42: pixel, 60: backlight unit, 64: LED, E: area, G: input image, H: light transmission level, K: brightness level

1. A drive circuit for driving a display panel and a backlight, the display including a plurality of pixels and the backlight including a plurality of light sources, the display panel in which a critical light transmission level is set in advance, the critical light transmission level being a minimum level of light transmission level for causing each of the pixels to respond in a predetermined time upon an input of an input image, the drive circuit comprising:
a brightness level determining circuit configured to divide the input image into a plurality of areas and determine brightness levels for the areas based on the input image corresponding to the areas, the brightness levels indicating brightness of the light sources corresponding to the area;
a light transmission level determining circuit configured to determine light transmission levels based on the input image and the brightness levels such that the light transmission levels are higher than the critical light transmission level, the light transmission levels indicating light transmission of the pixels.

2. The drive circuit according to claim 1, wherein the predetermined time is set based on a switching period in which the input image is switched.

3. The drive circuit according to claim 1, wherein the brightness level determining circuit includes a brightness table including the brightness levels each associated with each of the areas.

4. The drive circuit according to claim 3, further comprising a detection section configured to detect a maximum gradation level for each of the areas of the input image, wherein
the brightness levels in the brightness table are determined based on the maximum gradation level for each of the areas with which each of the brightness levels is associated.

5. The drive circuit according to claim 3, wherein
the light transmission level determining circuit includes a light transmission table including the light transmission levels each associated with each of pixels, and
the light transmission levels in the light transmission table are determined based on the brightness levels in the brightness table for each of the pixels with which each of the light transmission levels is associated.

6. A method of driving a display panel and a backlight, the display panel including a plurality of pixels and the backlight including a plurality of light sources, the display panel in which a critical light transmission level is set in advance, the critical light transmission level being a minimum level of light transmission levels for causing each of the pixels to respond in a predetermined time upon an input of an input image, the method comprising:
dividing the input image into a plurality of areas and determining brightness levels for the areas based on the input image corresponding to the areas, the brightness levels indicating brightness of the light sources corresponding to the area; and
determining light transmission levels based on the input image and the brightness levels such that the light transmission levels are higher than the critical transmission level, the light transmission levels indicating light transmission of the pixels.

7. A display device configured to control a brightness of a backlight, the display device comprising:
a display panel including a plurality of pixels, the display panel in which a critical light transmission level is set in advance, the critical light transmission level being a minimum level of light transmission level for causing each of the pixels to respond in a predetermined time upon an input of the input image;
a backlight including a plurality of light sources;
a brightness level determining circuit configured to divide an input image into a plurality of areas and determine brightness levels for the areas based on the input image corresponding to the areas, the brightness levels indicating brightness of the light sources corresponding to the areas;
a light transmission level determining circuit configured to determine light transmission levels based on the input image and the brightness levels such that the light transmission levels are higher than the critical light transmission level, the light transmission levels indicating light transmission of the pixels;
a backlight driving section configured to control the brightness of each of the light sources of the backlight based on the brightness levels; and
a panel driving section configured to control the light transmission of each of the pixels of the display panel based on the light transmission levels.

8. The display device according to claim 7, wherein the backlight drive section is configured to change a duty cycle of power applied to each of the light sources for controlling the brightness of each of the light sources.

9. The display device according to claim 7, wherein the light sources are LEDs.

10. The display device according to claim 7, wherein the display panel is a liquid crystal panel using liquid crystals.
